(19) United States
(12) Patent Application Publication
(10) Pub. No.: US 2009/0045918 A1
(43) Pub. Date: Feb. 19, 2009

(54) ELECTRONIC LABEL, METHOD FOR CONTROLLING PRODUCTS AND METHOD FOR DATA COMMUNICATION

(75) Inventors: Manuel DROESLER, Stahnsdorf (DE); Diran DAIRANI, Berlin (DE); Andre WUTTKE, Blankenfelde (DE)

Correspondence Address: BANNER & WITCOFF, LTD., 28 STATE STREET, 28th FLOOR, BOSTON, MA, 02109-9601, US

(73) Assignee: GTI Gesellschaft fur technische Informatik mbH, Stahnsdorf (DE)

(21) Appl. No.: 12/193,269

(22) Filed: Aug. 18, 2008

Related U.S. Application Data
(63) Continuation of application No. PCT/EP2007/001680, filed on Feb. 27, 2007.

(30) Foreign Application Priority Data
Feb. 27, 2006 (DE) 10 2006 010 159.6

(51) Int. Cl. H04Q 5/22

(52) U.S. Cl. 340/10.1; 340/10.2

(57) ABSTRACT

The invention relates to an electronic label and a method for controlling products. According to the invention, the label comprises at least one support component; at least one support component; at least one antenna; at least one transponder; at least one display, the display comprising electronic ink arranged on a support; and a least one sensor means. The product is provided with the label according to the invention for controlling the product.

### RELATED APPLICATIONS

This application is a continuation of PCT application no. PCT/EP2007/001680, designating the United States and filed Feb. 27, 2007; which claims the benefit of the filing date of German application no. DE 10 2006 010 159.6, filed Feb. 27, 2006; each of which is hereby incorporated herein by reference in its entirety for all purposes.

### BACKGROUND

The present invention relates to an electronic label and to a method for monitoring products by means of said label. The invention also relates to a method for data communication.

In almost all applications in the fields of storage, logistics and transport of materials and articles, it is necessary to mark the individual storage units or transport units in such a way that people can clearly identify the contents from outside, without having to open the packed unit. The conventional solution to this problem currently consists in applying non-reusable paper or film labels which are written on or printed on prior to being applied to the packed unit.

The labelling of packed units is problematic. Resources such as label paper are used in huge numbers since it is not possible to reuse them. Furthermore, once information has been applied to a label, it can be modified or corrected only in a very complicated and cost-intensive manner (manually or by sticking another label over it), since such labels can only be modified manually by being overwritten or by having another label stuck over them.

In particular the last-mentioned disadvantage of conventional labels for packed units is amplified in cases where the marked product has a batch- or series-related usability status which changes during the storage or transport time. In these cases, it is essential to be able to ascertain the current status of the product for clear identification from outside. In various branches of industry, such as the pharmaceutical, cosmetic, food, biotechnology and medical engineering sectors for example, the marking of the status of starting materials, semi-finished products and finished products is even a legal obligation for the manufacturers and transporters.

In order to solve this problem, nowadays suitable, machine-readable identification codes are applied to the labels. As the identification codes, barcodes are used which indicate the current status of the product unit of a batch or series. For this, however, the aid of a computer-assisted system is required. This means that it is not possible to make the current status visible to people without using auxiliary systems.

Also known are so-called smart labels. Such smart labels can be equipped for example with transponder systems (so-called RFID tags) which can be interrogated in a contactless manner and via which information can be called up. The RFID transponder is generally composed of an antenna, an analogue circuit for receiving and transmitting (transponder), a digital circuit and a permanent memory.

In general, a distinction is made between active and passive RFID transponders. Passive RFID transponders have no power supply and have to obtain their supply voltage by induction from the radio signals of the base station. Active RFID transponders have their own power supply and achieve a much greater range. They have a wider functional scope but also entail much higher costs per unit.

Such a smart label is described for example in DE 0 699 08 381 T2. The label comprises layers which are stacked with one another. The layers comprise an antenna element, a processor, a memory and also a display module. On the label, information can be displayed and modified.

DE 600 00 478 T2 describes another embodiment of a smart label. The label has two electrical attachment pads consisting of a first electric material, a layer consisting of a dielectric material, an antenna consisting of a second electric material and an expandable material. The expandable material forms a cavity which surrounds the attachment pads and accommodates a chip in the form of an integrated circuit.

In addition, DE 102 04 884 A1 describes a smart label which can be applied to a metal object. The label has a resonant circuit with a resonant frequency in the standard RFID range of 13.56 MHz and a film with increased permeability. The thickness of the film and its permeability are adapted to the metal object in such a way that the label is sufficiently magnetically shielded.

DE 103 36 321 A1 also describes a smart label, which has an electronic circuit, a memory and a device for data transmission and also a sensitive region. When the sensitive region registers that it is being acted upon in a targeted manner, it generates a pulse for the control means connected to the device for data transmission. The control means then enables a data transmission of data located on the label to a display device, on which a user can view the data.

The object of the invention is to provide a convenient, reusable label which can be operated independently and can be modified from a distance. The label should moreover be capable of displaying information in a man-readable form and also of allowing a detection of damage suffered during storage and transport.

Another object of the invention is to provide a method which is suitable for monitoring products.

Another object of the invention is to provide a method which allows data communication between a data communication centre and a plurality of labels in an effective manner with few errors.

### SUMMARY

According to the invention, the label comprises
at least one support component,
at least one antenna,
at least one display, the display comprising electronic ink arranged on a support,
at least one transponder, and
at least one sensor means.

The label thus comprises components which allow a man-readable display, a permanent storage of data and the detection and processing of data from the surroundings.

Overall, the present invention provides a reusable electronic label which meets the following requirements:
it can be produced in different sizes in the same way as labels customary today,
it is flat and flexible and can therefore be easily applied to a wide range of receptacles, packed units and containers,
it can be written to multiple times and randomly with man-readable alphanumeric characters and symbols,
certain information in the display (for example the status) can be modified by suitable signals from outside, and
all the identification information can additionally be stored in electronic form in a memory.

Such a label can be produced economically in large numbers. Costs can be saved due to the reusability, the fact that there is no need to move products in and out of storage and the fact that there is no need for relabelling when modifying the displayed information. The savings that are made compensate the additional costs of the devices which are required for writing or modifying information on the label.

According to the invention, a method for monitoring products is also provided, which comprises providing the product with a label according to the invention and recording, detecting, modifying and/or saving information on the electronic label.

In particular, information is recorded on the label in a form which can be read by a person without using auxiliary means. The recorded information is retained even without any power supply to the label, i.e. it is permanently stored and can be permanently displayed on the label. The permanent, man-readable display of information is in particular a property of the electronic ink that is used, in which a microcapsule is used to represent a pixel. Inside the capsule, positively or negatively charged particles are incorporated in an oily liquid or a gel. The particles are for example white and black. The microcapsules are arranged between an inner and an outer electrode in each case in the form of a film, as a result of which the actuation of individual pixels is possible via the electrodes. If a positive electric field is applied via the inner electrode, the white particles move towards the surface of the microcapsule. At the same time, a negative field is applied via the outer electrode, which is transparent, and said negative field moves the black particles inwards and thus makes them invisible. A white pixel is thus generated. The generation of a black pixel takes place in an analogous manner. The orientation of the pixels is stable, so that the display of information does not cease even without an external power supply.

The method according to the invention for data communication between a data communication centre and a plurality of labels comprises the steps which are carried out by at least one of the labels:
receiving a data packet which originates from the data communication centre and/or from the one label itself and/or from another label;
processing the data packet within the label;
checking, based on the data packet, whether the one label is the desired addressee for the data packet;
if the check shows that the one label is not the desired addressee for the data packet, then transmitting the data packet to the data communication centre and/or to another label and/or to the label itself.

The labels usually appear in large numbers in a non-homogeneous spatial distribution, and are in individual communication with the data communication centre. According to the invention, the data communication between the data communication centre and the plurality of labels is brought about via the labels themselves, so that each label need not be directly connected to the data communication centre. It is therefore sufficient if at least one single label is in data communication with the data communication centre, since the labels carry out a data exchange with one another. This means that each label receives the data intended for it, even if this label is not directly connected to the data communication centre. The data communication between the data communication centre and the individual labels is thus simple and contains few errors.

### Detailed Description of Certain Preferred Embodiments

In preferred embodiments, the at least one sensor means is a sensor means for detecting a temperature, in particular the ambient temperature. By detecting the temperature, it can be ascertained whether a receptacle provided with the label is being stored within a permissible temperature range. This is particularly important in the case of refrigerated products, in the case of medicaments and in the case of temperature-sensitive starting materials which require storage within a certain temperature range. For example, the purchaser of refrigerated products can see by looking at the label according to the invention the detected temperature values stored in the label, and can thus ascertain whether the product has been transported and stored within a predefined temperature range or whether the product has been exposed during transport or storage to a temperature which is not within the predefined range.

As an alternative or in addition, the sensor is a sensor for detecting a pressure, in particular the ambient pressure. By looking at the label according to the invention, it can be ascertained whether a receptacle provided with the label was or is being exposed to pressure fluctuations. This is particularly important in the case of receptacles in which chemicals are stored, since chemicals may assume different structures under different pressures and may change as a result of being exposed to pressure, to the point of decomposition.

Within the context of the present invention, a transponder is understood to mean a transmitting and receiving unit. Advantageously, the transponder comprises an integrated circuit which contains further components. The integrated circuit advantageously furthermore comprises a processor and a memory, so that data can be processed and stored. The transponder is preferably an IC chip. In one advantageous embodiment, the sensor means is also integrated in the integrated circuit.

Preferably, the processor is suitable for controlling the at least one sensor means in such a way that the ambient temperature and/or the ambient pressure is detected at predefined time intervals, and the memory is suitable for storing the detected ambient temperature and/or the ambient pressure. This allows long-term recording of the storage temperature and/or of the storage pressure and makes it possible to verify that the product is being or has been stored within the predefined temperature and/or pressure range. Moreover, if the predefined temperature and/or pressure range is exceeded, the time during which the temperature and/or pressure was exceeded can be detected.

In one preferred embodiment, the processor is suitable for generating a signal which modifies the information in the display. By way of example, the processor may start or run one or more programs which are stored in the memory. It can thus define the information to be displayed by the display, and can generate a warning that the predefined temperature and/or pressure range has been exceeded. The warning is for example a flashing label display. As an alternative, the colour of the label display, i.e. of the support or of the electronic ink, may also change. The usability status may change for example if a certain batch is blocked due to a lack of shelf life or since it presents a hazard.

In a further preferred embodiment, the electronic ink is an electronic ink which changes its colour as a function of the temperature detected by the sensor means. As a result, damage suffered during storage for example in the case of refrigerated products can be displayed such that it is immediately visible to people. One example of an electronic ink which is capable of changing colour is based on particles which are stacked in a polymer gel matrix. A voltage is applied to the conductive polymer gel, which voltage positively charges the polymer to a greater or lesser extent and defines how much solvent is absorbed by the gel. Depending on the absorbed quantity of solvent, the gel swells and the distances between the particles change. Depending on the distance between the particles, certain wavelengths of the impinging light are eliminated, which gives rise to a colour impression. If the ink appears for example in a blue colour on the display, this indicates that it is within a temperature range of 0 to 10° C. If the ink appears in a red colour on the display, this indicates that it is within a temperature range of 11 to 25° C. If the ink is visible in a red colour on the display, the purchaser of a refrigerated product which has to be stored at a temperature of 0 to 10° C. can immediately see at a glance upon receipt of the product that the permissible temperature range has been exceeded, and the product is therefore faulty. The support on which the electronic ink is arranged is in particular a polymer material such as plastic for example.

In one advantageous embodiment, the antenna comprises an HF/UHF antenna. Alternatively, the antenna consists of a dipole with an antenna coil integrated in the circuit and an antenna applied to the support material.

The support component advantageously comprises plastics. Plastics are inexpensive materials. For applying the label to a surface, the support component advantageously has an adhesive layer. The support material advantageously comprises polyethylene. Polyethylene is an inexpensive material and may additionally exhibit adhesion-promoting properties by incorporating adhesion-promoting compounds during its production. Alternatively, the support component comprises polyimide. Polyimide has good thermal properties.

The support component, the antenna, the display, the transponder, the sensor means and/or further components of the label according to the invention are advantageously connected to one another. By way of example, the components of the label can be connected to one another by gluing, moulding or soldering.

In one preferred embodiment, the label is of layered design. That is to say that it comprises at least one each of a support component layer, antenna layer, display layer and a controller layer which contains the transponder, the sensor means, the processor and the memory. Due to the layered design of the label, the label is flat and does not protrude. The layers are preferably arranged in a stack. The label has in particular a thickness of 1.5 to 5.0 mm.

The label has at least one sensor means which first has to be effectively addressed in order that information or data on the label can be recorded and/or modified. The addressing of the sensor means takes place by acting upon the label in a targeted manner. By way of example, the label may be acted upon by a radio signal. As a result, a signal is generated so that the processor executes commands. By way of example, the processor may cause the sensor means to detect the ambient temperature and may cause the memory to store the detected ambient temperature. On the one hand, therefore, ambient temperatures of the label can be detected, and the detected ambient temperatures during shipping can be interrogated by a purchaser of a product provided with the label.

Furthermore, the processor may be connected to a control means, to which it outputs a signal after being effectively acted upon, with the signal being the sign for the control means to check the authorization of an access to data stored in the label. Preferably, the label according to the invention comprises the control means.

By way of example, there is an electrical connection between the label and an authorization device. The transponder and the antenna receive a respective signal from the authorization device of the purchaser. Energy is supplied to the processor via the signal received by the antenna, while a data code is transmitted to the processor via the signal received by the transponder. The processor processes the data code output by the transponder and generates a data code signal which is output to the control means. The control means checks, based on the data code signal, whether the identity permits access to data stored in the memory of the label and generates a signal which releases the data or indicates an unauthorized access.

The present invention also relates to a method for monitoring products. The term “product” means all objects that can be labelled, in particular piece goods, receptacles, packed units, containers, pallets, cars, animals and the like. The method comprises providing a product with a label which comprises at least one support component, at least one antenna, at least one display, including electronic ink arranged on a support, at least one transponder and at least one sensor means, and recording, detecting, modifying and/or saving information on the electronic label. Providing products with such a label allows wireless monitoring of the product. The label represents an electronic marking, and all the important information and data are written to the memory of the label. By way of example, this information may be all the data required for secure storage of the product. Particularly when storing chemicals or pharmaceuticals, these data are for example the permissible current usability status, the storage temperature, hazard symbols, R/S statements and further safety instructions. Furthermore, the display of the electronic label can be modified if for example an ambient temperature and/or an ambient pressure which lies outside a predefined permissible temperature and/or pressure range is detected by the sensor means, which is suitable for example for detecting the ambient temperature and/or the ambient pressure of the label.

In one preferred embodiment of the method, the information is written to the memory of the label in at least partially encrypted form and/or is encrypted in the memory. This increases the level of security against falsification. During transport, therefore, neither the sender data nor the receiver data can be manipulated, and nor is it possible for data detected by the temperature sensor for example to be modified without the proper authorization and without identifying and recording the person modifying the data. It is thus possible for example for products to be easily assigned to the receiver and sender at customs and also for attempts at manipulation to be displayed.

In one preferred embodiment of the present invention, the information in the memory of the label can repeatedly be deleted and new information can repeatedly be written. The label is therefore reusable. In addition, it can also be supplemented by information or other components. By way of example, an intermediate purchaser who further processes a received intermediate product can add his manufacturing data to the label. Preferably, an authorization is requested before modifying information on the label, in order to increase the level of security of the label.

In one preferred embodiment of the method according to the invention, the label is addressed by an external device at predefined time intervals. The external device is in particular a write/read device, such as for example a transmitter which transmits a signal to the processor of the label. As a result, energy is supplied to the label and accesses such as reading, writing and/or detecting a temperature and/or a pressure with the label are possible. Here, energy is transmitted via a magnetic field which is built up between the external device and the label. A change in voltage in the write/read device leads to a change in field strength, which causes a change in voltage in the label. The strength and length of the signal of the external device is matched to the energy requirement of the label. The energy requirement is determined by the quantity of data to be transmitted and the distance between the external device and the label, the power consumption of individual label components and by the type of access. For example, write accesses require more energy than read accesses. The signal which is transmitted by the external device to the label has in particular a frequency in the range from 1 to 10 MHz.

The addressing of the label by an external device at predefined time intervals allows an energy supply which takes place at regular time intervals. The processor is advantageously programmed in such a way that, when energy is supplied by an external device, it causes the sensor means to measure the temperature and/or the pressure. The sensor means outputs the detected temperature and/or the detected pressure to the processor. The processor causes a memory to store the detected temperature and/or the detected pressure. The memory may be arranged in the label according to the invention. As an alternative or in addition, the memory is an external memory device. On the basis of the detected temperature, the processor may also cause the thermochromatic ink to change its colour.

In one preferred embodiment of the invention, the information which is written to the label is read at predefined time intervals. This is particularly useful when stocks are to be checked. It is possible in this way to carry out an electronic stocktake. By way of example, the stock may be checked always on the last day of the month. Furthermore, by detecting the temperature data, it can be ascertained whether for example a cooling device has reached the limit of its cooling capacity if for example all the labels located in the cooling device output temperature data which lie close to the permitted limit of the predefined temperature range.

Preferably, the method according to the invention for data communication between a data communication centre and a plurality of labels comprises the step: checking whether the label is the desired addressee for the data packet, based on an identifier generated by the data communication centre and adhering to the data packet.

As a result, the address for the desired label is generated by the data communication centre, with the data packet comprising the address.

The method furthermore comprises the step: checking whether the received data pack is complete and/or free of errors and/or superposed with another data packet.

As a result, the data packet which is transmitted by one to another label is checked for correctness. The data transmission between the individual labels therefore contains few errors, as a result of which the error rate in the data communication between the data communication centre and the desired label is low.

Furthermore, it is preferred that the method comprises the steps: checking, based on the data packet, whether a response data packet is required in response to the data packet; generating the response data packet as a function of the data packet; transmitting the response data packet to the data communication centre and/or to another label and/or to the one label itself.

As a result, the label in question is in reciprocal communication with the data communication centre, so that a dialogue is possible between the corresponding label and the data communication centre.

It is preferred that the method comprises the steps: checking whether the data packet has already been received as an identical packet by the one label; if the check shows that the data packet has already been received as an identical data packet by the one label, then rejecting the data packet.

A double and thus redundant processing of the data packets is not necessary since this does not represent any increase in information. The fact that a data packet which has already been received as an identical data packet is rejected prevents a data packet which has already been received from being processed again at a later point in time. The amount of data processing in each individual label is thus minimal.

Furthermore, the method comprises the step: providing the label with a message ring memory for at least two data packets.

By means of the message ring memory, advantageously at least two data packets can be stored which can be used for identity checking.

The method preferably comprises the step: transmitting the data packet only after the lapse of a predefined waiting time which is different from a waiting time of at least one other label.

This advantageously means that a plurality of labels and/or the data communication centre do not each simultaneously transmit a data packet, and the individual data packets therefore do not interfere with one another.

It is preferred that the method comprises the steps: checking, before the start of transmission of the data packet, whether another data packet can be received simultaneously; if the check shows that another data packet can be received simultaneously before the start of transmission of the data packet, then allowing the waiting time to lapse again and re-transmitting the data packet.

This advantageously means that a plurality of labels and/or the data communication centre do not each simultaneously transmit a data packet, and therefore the individual data packets do not interfere with one another.

Preferably, the method comprises the steps: upon transmission of the data packet, receipt of the latter by the one label and checking whether the transmitted data packet is complete and/or free of errors; if the check shows that the transmitted data packet is incomplete and/or contains errors, then allowing the waiting time to lapse again and re-transmitting the data packet.

As a result, the error rate upon transmission of the data packet by the respective label is advantageously minimal.

Preferably, the method comprises the step: checking the data packet by means of a CRC checksum procedure.

### BRIEF DESCRIPTION OF THE DRAWINGS

An example of embodiment of a label according to the invention will be explained in more detail below with reference to the appended schematic drawings.

FIG. 1 shows a schematic diagram of an electronic label according to the invention, and

FIG. 2 shows a schematic view which shows a further embodiment of an electronic label according to the present invention.

### DETAILED DESCRIPTION OF THE EXAMPLE OF EMBODIMENT

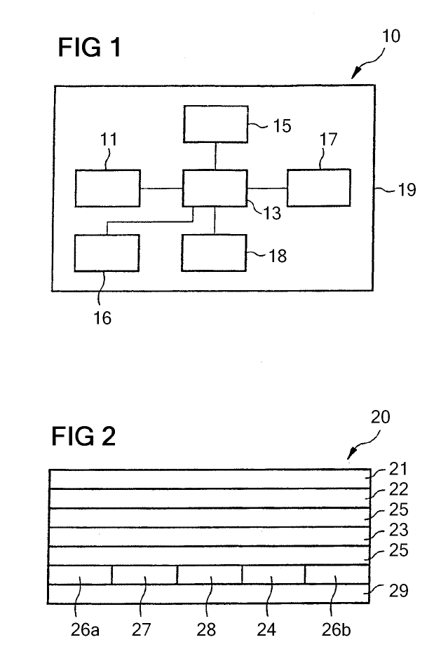

FIG. 1 is a schematic diagram of a label 10 according to the invention. The label 10 comprises a transmitting/receiving device 11 which is connected to a processor 13. The processor 13 is also respectively connected to a sensor 15, an antenna 16, a display 17 and a memory 18. The transmitting/receiving device 11, the processor 13 and the memory 18 form an integrated circuit of the label 10, which forms the transponder. The aforementioned components are arranged on polyethylene as the support component 19, which furthermore has on one side an adhesive layer for applying the label to a surface.

The label 10 comprises a transmitting/receiving device 11 which is capable of transmitting and receiving commands and information or data. When the transmitting/receiving device 11 receives an outward signal, it generates in response to this signal an output signal which is received by the processor 13. The processor 13 processes the output signal of the transmitting/receiving device 11 in order to carry out a selected number of functions. The processor can connect to the memory 18 in order to store new information or data or to access or retrieve selected information or data stored therein. The information or data may be computer programs, commands, stored pixel addresses or the like which can be used to define the specific details which are displayed by the display. The memory 18 may store a label identification number, a product code, a name, hazard symbols, a selling price, manufacturing data, manufacturer data, a stock number, a use-by date, encryption software, security and theft prevention software and the like.

The antenna 16 serves for supplying the label 10 with energy. The antenna 16 is capable of receiving radio signals from an external device (not shown) and outputting these to the processor 13.

The processor 13 and the memory 18 form a unit for providing the information which is to be displayed by the display 17. The processor 13 may perform the following tasks: starting or running a number of programs which are stored in the memory in order to define the details that are displayed by the display 17. The processor 13 may also process commands which it receives from the transmitting/receiving unit 11. Furthermore, the processor 13 may generate an output signal in order to activate the display 17 and in order to display selected details on the basis of executed commands. The information that is used may be stored locally in the label 10, may be generated or may be received from the transmitting/receiving device 11.

The processor 13 may also supply a signal to the sensor 15. The sensor 15 comprises a temperature sensor means which detects the ambient temperature, and a pressure sensor means which detects the ambient pressure. Via the signal from the processor 13, the sensor 15 is made to measure the ambient temperature and the ambient pressure of the label 10, and to output the detected ambient temperature and the detected ambient pressure to the processor 13. The processor 13 can process the data received from the sensor 15 such that said data are stored in the memory 18 and such that an alarm signal is supplied to the display 17 if a predefined temperature range is exceeded.

FIG. 2 is a schematic view which shows an embodiment according to the invention of an electronic label in the form of assembled layers. The label 20 is designed as a structure which comprises a number of layers, so that each layer is capable of performing a selected function. The layers can be combined with one another in order to form a single functional electronic label. The label 20 comprises a protective layer 21 which is arranged above a display layer 22 as the display of the label 20. Arranged between the display layer 22 and an antenna 23 is a shield 25 which serves for shielding the antenna 23. The antenna 23 serves for power uptake. Also arranged on the antenna 23 is a further shield 25, on which an integrated circuit is arranged. The integrated circuit comprises a sensor 24, a transmitter 26a, a receiver 26b, a processor 27 and a memory 28. The transmitter 26a and the receiver 26b form the transponder. The sensor 24 serves for detecting the ambient temperature, while the transmitter 26a serves for transmitting data from the label 20 to an external device (not shown), and the receiver 26b serves for receiving data which are transmitted to the label 20 from an external device (not shown). The processor 27 processes the data which are stored in the memory 28, which are received by the receiver 26b or the sensor 24 or which are transmitted by the transmitter 26a. In order to attach the label 20 to a surface, an adhesive layer 29 is arranged as the support component on the integrated circuit.

In order to prevent the electronic ink from inadvertently being mechanically damaged and/or suffering from environmental damage, a protective layer 21 is arranged above the display layer 22. The display layer 22 comprises electronic ink which is used with an electronic activation grid which is arranged on a support structure in order to form the display. The activation grid is operated in such a way that it forms a plurality of addressable pixel positions, wherein each pixel can be addressed by the integrated circuit 28, which contains a processor. The processor in the integrated circuit 28 can control, address, change or modify each pixel position in the activation grid. Overall, the display layer 22 forms a man-readable display.

The label 20 also contains the antenna 23. Via the antenna 23, the label 20 is supplied with energy. To this end, energy is transmitted via a magnetic field which is built up between an external device, such as a write/read device, and the label 20. A change in voltage in the write/read device leads to a change in field strength, which brings about a change in voltage in the antenna 23. The antenna 23 receives an input signal from the external device and generates an output signal to the processor 27 for supplying the label 20 with energy.

The label 20 also comprises an integrated circuit. The integrated circuit comprises the receiver 26a and also the transmitter 26b. The transmitter 26b and the receiver 26a serve for exchanging data with external devices.

The integrated circuit also comprises the processor 27 and the memory 28. The processor 27 serves for processing signals and/or data or information, in particular data which are output thereto from the antenna 23, the sensor 24, the transmitter 26a, the receiver 26b and the memory 28. Stored in the memory 28 are the data and also further programs and/or commands which can be accessed by the processor 27.

The processor 27 is connected to the sensor 24. The sensor 24 comprises a temperature sensor means for detecting the ambient temperature of the label 20 and a pressure sensor means for detecting the ambient pressure of the label 20. In response to a command from the processor 27, the sensor 24 detects the ambient temperature and the ambient pressure and outputs the detected ambient temperature and the detected ambient pressure to the processor 27.

The integrated circuit is preferably electrically connected to at least one of the layers of the electronic label 20, in particular to the display layer 22 and the antenna 23. The integrated circuit furthermore serves as a holding layer for providing a wide range of electrical components which can be arranged in the label 20. Examples of such components are further memories, interfaces or sensors.

Finally, it should be noted that all the features which are mentioned in the application documents and in particular in the dependent claims, in spite of any formal reference back to one or more specific claims, are also intended to be assigned independent protection individually or in any combination.

### FIGURE REFERENCES

10 label
11 transmitting/receiving device
13 processor
15 sensor
16 antenna
17 display
18 memory
19 support component
20 label
21 protective layer
22 display layer
23 antenna
24 sensor layer
25 shield
26a transmitter
26b receiver
27 memory
28 processor
29 adhesive layer

1. A label which comprises:
at least one support component;
at least one antenna;
at least one display, the display comprising electronic ink arranged on a support;
at least one transponder; and
at least one sensor.

2. The label according to claim 1, characterized in that the sensor is a temperature sensor.

3. The label according to claim 1, characterized in that the sensor is a pressure sensor.

4. The label according to claim 1, wherein the transponder comprises an integrated circuit.

5. The label according to claim 4, wherein the integrated circuit furthermore comprises a processor and a memory.

6. The label according to claim 2, wherein the electronic ink is capable of changing colour as a function of the temperature detected by the sensor.

7. The label according to claim 1, wherein the antenna comprises an HF/UHF antenna.

8. The label according to claim 1, wherein the support comprises polyethylene.

9. The label according to claim 1, being in layered design.

10. The label according to claim 5, wherein the processor is connected to a control device.

11. A method for monitoring products, which comprises providing the product with a label according to claim 1 and recording, detecting, modifying and/or saving information on the electronic label.

12. The method according to claim 11, wherein the information is written to a memory of the label in at least partially encrypted form.

13. The method according to claim 11, wherein an authorization is requested before modifying information on the label.

14. The method according to claim 11, wherein the label is addressed by an external device at predefined time intervals.

15. A method for data communication between a data communication centre and a plurality of labels, comprising the steps which are carried out by at least one of the labels:
receiving a data packet which originates from the data communication centre or from the one label itself or from another label;
processing the data packet within the label;
checking, based on the data packet, whether the one label is the desired addressee for the data packet;
if the check shows that the one label is not the desired addressee for the data packet, then transmitting the data packet to the data communication centre or to another label or to the label itself.

16. The method according to claim 15, comprising the step of checking whether the label is the desired addressee for the data packet, based on an identifier generated by the data communication centre and adhering to the data packet.

17. The method according to claim 15, comprising the step of checking whether the received data pack is complete or free of errors or superposed with another data packet.

18. The method according to claim 17, comprising the step of checking the data packet by means of a CRC checksum procedure.

19. The method according to claim 15, comprising the steps:
checking, based on the data packet, whether a response data packet is required in response to the data packet;
generating the response data packet as a function of the data packet; and
transmitting the response data packet to the data communication centre or to another label or to the one label itself.

20. The method according to claim 15, comprising the steps:
checking whether the data packet has already been received as an identical packet by the one label; and
if the check shows that the data packet has already been received as an identical data packet by the one label, then rejecting the data packet.

21. The method according to claim 20, comprising the step of providing the label with a message ring memory for at least two data packets.

22. The method according to claim 15, comprising the step of transmitting the data packet only after the lapse of a predefined waiting time which is different from a waiting time of at least one other label.

23. The method according to claim 22, comprising the steps:
checking, before the start of transmission of the data packet, whether another data packet can be received simultaneously; and
if the check shows that another data packet can be received simultaneously before the start of transmission of the data packet, then allowing the waiting time to lapse again and re-transmitting the data packet.

24. The method according to claim 15, comprising the steps:
upon transmission of the data packet, receipt of the latter by the one label and checking whether the transmitted data packet is complete or free of errors; and
if the check shows that the transmitted data packet is incomplete or contains errors, then allowing the waiting time to lapse again and re-transmitting the data packet.

25. The method according to claim 15, comprising the step of checking the data packet by means of a CRC checksum procedure.
